(19) United States
(12) Patent Application Publication
(10) Pub. No.: US 2011/0233997 A1
(43) Pub. Date: Sep. 29, 2011

(54) POWER SUPPLY APPARATUS, POWER RECEPTION APPARATUS, AND POWER SUPPLY METHOD

(75) Inventor: Shigeru TAJIMA, Kanagawa (JP)

(73) Assignee: Sony Corporation, Tokyo (JP)

(21) Appl. No.: 13/153,993

(22) Filed: Jun. 6, 2011

Related U.S. Application Data
(63) Continuation of application No. PCT/JP2010/007313, filed on Dec. 16, 2010.

(30) Foreign Application Priority Data
Dec. 25, 2009 (JP) 2009-295580

(51) Int. Cl. B60L 1/00; H02J 4/00

(52) U.S. Cl. 307/9.1; 307/11

(57) ABSTRACT

A server, client and method cooperate to provide packetized power to a client device from a power server, where the packetized power is compatible with the power profiled required by the client device. The packetized power is provided according to a priority that can be set by the client, depending on various attributes and settings at the client. Also, dynamic reprioritization allows for newly connected clients or clients that have increased in priority over time to also be served packetized power according to their respective profiles.

### BACKGROUND

The present disclosure relates to a power supply apparatus, a power reception apparatus and a power supply method, more specifically, to a power supply apparatus, a power reception apparatus and an information notification method in which electric power and information are frequency-divided and can be used at the same time.

Many electronic devices such as personal computers and game machines use an AC adaptor, which inputs alternating-current (AC) from a commercial power source and outputs electric power matching requirements of the device, for the purpose of operating the device and charging the battery. Although the electronic device is usually operated by a direct current (DC), the voltage and current demands are different for each device. Thus, the AC adaptor outputting electric power matching each device is also different for each device. Accordingly, even if AC adaptors have similar shapes, they can be incompatible with each other, and there is an issue that the number of AC adaptors increases with increasing numbers of devices.

In order to solve the above issue, there has been proposed a power bus system in which a power supply block supplying electric power to devices such as a battery and an AC adaptor and a power consumption block receiving electric power from the power supply block are connected to a common DC bus line (for example, Japanese Patent Application Laid-Open No. 2001-306191 and Japanese Patent Application Laid-Open No. 2008-123051 cited below). In this power bus system, a DC current flows through a bus line. Further, in the power bus system, each block itself is described as an object, and the objects of the respective blocks mutually transmit and receive information (state data) through a bus line. The object of each block generates the information (state data) based on a request from the object of another block and transmits the information as reply data. The object of the block having received the reply data can control electric power supply and consumption based on the contents of the received reply data.

### SUMMARY

In the above power source bus system, some number of power supply sources (power supply servers) and consumers (clients) are dynamically connected to a system and the supply of power is performed based on an agreement between the power supply server and the client. Such a power source bus system is also considered as a system that realizes a maximum efficiency of power supply with a limited supply amount so that it may realize, at a local level, a desirable “smart grid” of an existing grid.

The existing grid has been made to control the amount of power supply capacity to be greater than demand to prevent a power failure and a power shortage. However, when it is assumed that electric vehicles will be widely spread in the future, a rapid increase of power demand may not be able to deal with grid base plates (a power generation amount in a power plant and a power transmission and distribution amount in a power network). A method for solving this problem as recognized by the present inventor is demand-side control in a smart grid.

Meanwhile, the above power source bus system demonstratively performs best where a balance between supply and demand is poor. This may cause a situation that demand of all loads (clients) is not satisfied so and a further improved demand-side control by a smart grid will be important. However, the power source bus system does not define this point and so there has been a problem that a concrete power supply control is not under consideration.

The present disclosure has been made in this point of view and has an object to provide a new and improved power supply apparatus, power reception apparatus, and power supply method in which power and information are frequency-divided and used at the same time to make an effective power supply control solution.

As recognized by the present inventors, client devices can set charging priority based on information they provide to a power server, such as client ID. The power server can then compare respective power requests from different client devices to decide a priority order. Once the priority is set, the power server can then route power packets to the appropriate clients so as to provide operational and charging power to the respective clients.

According to an embodiment of the present disclosure, there is provided a power server includes an interface configured to receive a power request from a client device, the power request including client specific information, and a processor configured to determine a priority for delivering power to the client device according to the client specific information.

The client specific information may include a client priority variable, and the processor may determine the priority according to the client priority variable received from the client device.

The processor may determine the priority based on a comparison of the client priority variable with another client priority variable received by the interface for another client device.

The client specific information may include a client ID, and the processor may determine the priority based on the client ID received from the client device.

The processor may determine the priority based on a comparison of respective client classifications for the client device and another device.

The client device may be an electric vehicle, and the interface may provide power to the electric vehicle according to the priority set according to the client specific information in the power request from the electric vehicle.

The processor may be configured to initiate a priority check when another device is newly coupled to the interface, and send power to the another device if the another device has client specific information that is recognized as being of a higher priority than the client specific information for the client device.

The interface may be configured to connect to a bus on which the client device is connected and other client devices are connectable and transmit respective power requests, and deliver a power packet to the client device on the bus, according to a power profile for the client device. The power request may be received during a first time slot, and the power packet may be transmitted by the power server over the bus during a second time slot.

According to another embodiment of the present disclosure, there is provided a client device includes a processor configured to generate a power request to be transmitted to a power server, the power request including client specific information, and an interface through which the power request is transmitted to the power server, and power is received in response from the power server according to a priority associated with the client specific information.

The client specific information may include a client priority variable. The power server may determine the priority from the client priority variable by comparison with another client priority variable from another client device.

The client specific information may include a client ID. The power server may determine the priority based on a comparison of respective client classifications for the client device and another device.

The client device may be an electric vehicle and the interface may receive power from the power server according to the priority set according to the client specific information in the power request from the electric vehicle.

The processor may be configured to generate the power request when the interface is connected to the power server via a bus.

The interface may connect to a bus on which the power server and other client devices are connectable, and may receive a power packet from the power server via the bus, according to a power profile for the client device. The power request may be transmitted on the bus during a first time slot, and the power packet may be received over the bus during a second time slot.

According to another embodiment of the present disclosure, there is provided a method for serving electrical power to a plurality of devices including sending a power request from a client device to a power server, the power request including client specific information, and establishing with a processor a priority for delivering power to the client device based on the client specific information.

The establishing may establish the priority by comparing a client priority variable to another client priority variable from another client device, the client priority variable being included in the power request.

The establishing may establish the priority by comparing respective client classifications for the client device and another device using a client ID for the client device, the client ID being included in the power request.

The method may further include initiating the establishing when the client device is newly connected to a bus that interconnects the power server and the client device.

The method may further include conveying a power packet from the power server to the client device according to a power profile for the client device.

The method may further include sending power packets to the client device but not to another device when the client device has a higher priority status than the other device, checking for a change in status and whether the another device has a higher priority status than the client device, and sending power packets to the other client device when the checking identifies the other client device as having a higher priority status than the client device.

One advantage with this approach is that it allows for clients with various power profiles to cooperate with a power server to satisfy their power needs.

As described above, the present disclosure has been made in this point of view and has an object to provide a new and improved power supply apparatus, power reception apparatus, and power supply method in which power and information are frequency-divided and used at the same time and an effective power supply control is available.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an explanatory view showing a constitution of a power supply system according to an embodiment of the present disclosure;

FIG. 2 is an explanatory view showing a power supply processing by a power supply system 1;

FIG. 3 is an explanatory view showing a constitution of a power supply server 100;

FIG. 4 is an explanatory view showing an arrangement of the client 200;

FIG. 5 is a flowchart showing a priority control according to an embodiment of the present disclosure; and

FIG. 6 is a flowchart showing a priority control according to an embodiment of the present disclosure.

### DETAILED DESCRIPTION OF THE EMBODIMENT(S)

Referring now to the drawings, wherein like reference numerals designate identical or corresponding parts throughout the several views.

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Descriptions will be made in the following order:

<1. An embodiment of the present disclosure>

(1-1. Constitution of power supply system)

(1-2. Power supply processing by power supply system)

(1-3. Constitution of power supply server)

(1-4. Constitution of client)

(1-5. Operation of power supply server and client)<

2. Conclusion>

### 1. AN EMBODIMENT OF THE PRESENT DISCLOSURE

(1-1. Constitution of Power Supply System)

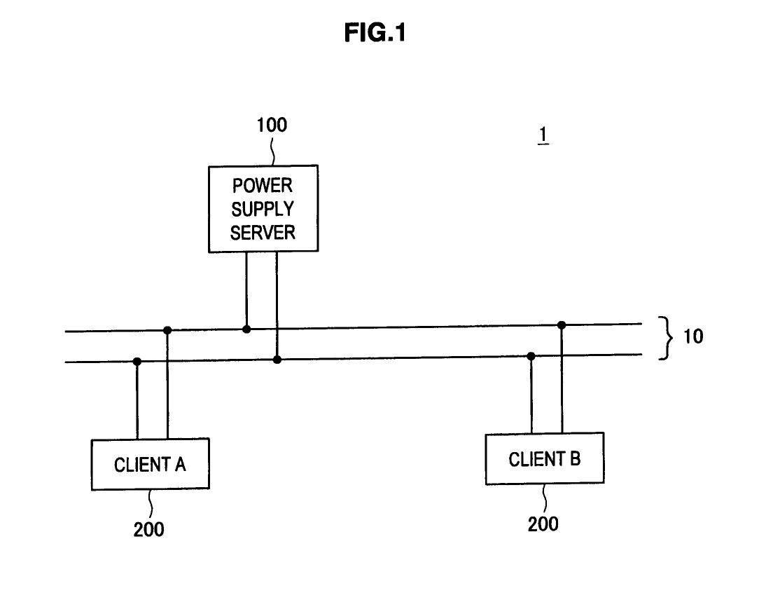

First, a constitution of a power supply system according to an embodiment of the present disclosure will be described. FIG. 1 is an explanatory view showing the constitution of the power supply system according to the embodiment of the present disclosure. Hereinafter, the constitution of the power supply system according to the embodiment of the present disclosure will be described using FIG. 1.

As shown in FIG. 1, a power supply system 1 according to an embodiment of the present disclosure is configured to include a power supply server 100 and a client 200 (shown as Client A and Client B). The power supply server 100 and the client 200 are connected to each other through a bus line 10.

The power supply server 100 supplies DC power to the client 200. The power supply server 100 further transmits and receives an information signal to and from the client 200. In the present embodiment, the DC power supply and the transmission and reception of the information signal between the power supply server 100 and the client 200 are shared on the bus line 10, which may or may not include multiple conductors.

The power supply server 100 is configured to include a communication modem for use in transmitting and receiving the information signal and a microprocessor for use in controlling an electric power supply, and a switch controlling a DC power output.

The client 200 receives the DC power supplied from the power supply server 100. The client 200 further transmits and receives the information signal to and from the power supply server 100. In FIG. 1, the two clients 200 are illustrated.

The client 200 is configured to include a communication modem for use in transmitting and receiving the information signal and a microprocessor for use in controlling the electric power supply, and a switch controlling the DC power output.

In the power supply system 1 shown in FIG. 1, the single power supply server 100 and the two clients 200 are illustrated. However, in the present disclosure, the number of the power supply servers and the number of the clients are not obviously limited to the example.

Since a method of supplying electric power in the power supply systems 1 and 2 shown in FIG. 1 is described in the Patent Literature 2 (Japanese Patent Application Laid-Open No. 2008-123051), the contents of which being incorporated herein by reference, the express detailed description will be omitted. However, hereinafter, a power supply processing by the power supply system 1 according to an embodiment of the present disclosure will be briefly described.

(1-2. Power Supply Processing by Power Supply System)

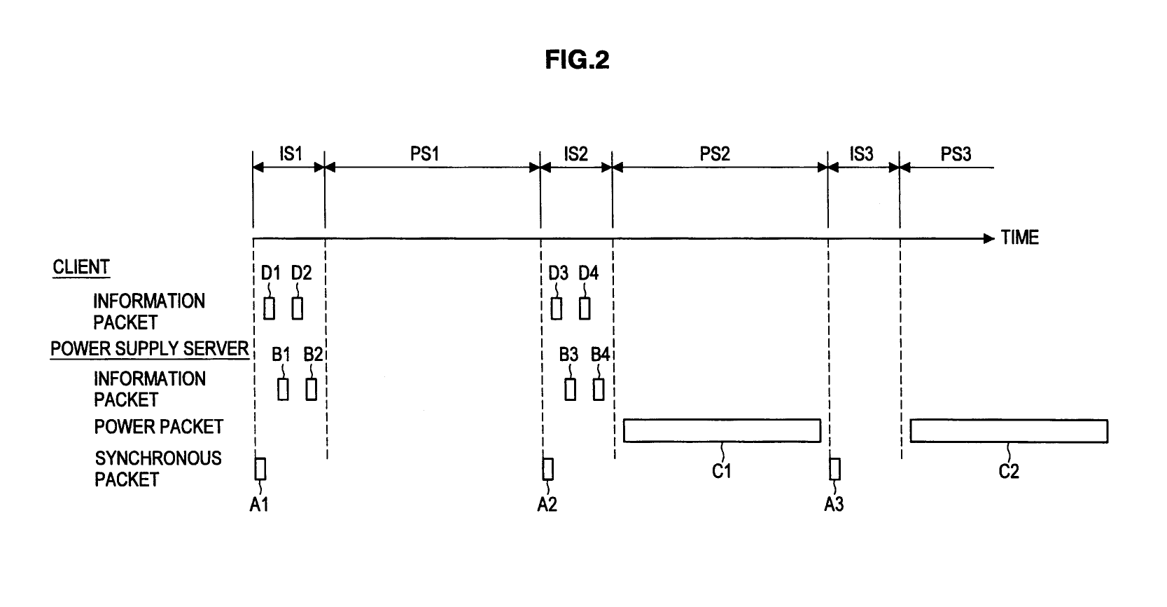

FIG. 2 is an explanatory view for explaining the power supply processing by the power supply system 1 according to an embodiment of the present disclosure. Hereinafter, the power supply processing by the power supply system 1 according to each of the embodiments of the present disclosure will be described using FIG. 2.

As shown in FIG. 2, the power supply server 100 periodically outputs synchronous packets A1, A2, A3, . . . to the bus line 10. The power supply server 100 further outputs information packets B1, B2, B3, . . . and power packets C1, C2, C3, . . . so as to supply electric power to the client 200. The information packets B1, B2, B3, . . . are the information signals transmitted and received to and from the client 200, and the power packets C1, C2, C3, . . . are obtained by packetizing electric energy in a predetermined format. Meanwhile, the client 200 outputs information packets D1, D2, D3, . . . that are the information signals transmitted and received to and from the power supply server 100 so as to receive electric power supplied from the power supply server 100 in an appropriate format for use by respective clients.

The power supply server 100 outputs the synchronous packets A1, A2, A3, . . . at the start of a time slot of a predetermined interval (for example, every 1 second). The time slot includes an information slot through which the information packet is transmitted and a power slot through which the power packet (sometimes referred to as energy packet) is transmitted. Information slots IS1, IS2, IS3, . . . are sections where the information packets are exchanged between the power supply server 100 and the client 200. Power supply slots PS1, PS2, PS3, . . . are sections (or intervals) where the power packets C1, C2, C3, . . . supplied from the power supply server 100 to the client 200 are output. The information packet is a packet that is output only in the sections of the information slots IS1, IS2, IS3, . . . . Thus, when the transmission and reception of the information packet is not, or cannot be, completed in one information slot, the information packet (or an entirety of information message to be conveyed) is transmitted over a plurality of information slots. Meanwhile, the power packet is a packet that is output only in the sections of the power supply slots PS1, PS2, PS3, . . . .

The power supply server 100 can accommodate one, or two, or more server power supply profiles, which respectively describe a power specification that can be supplied by the power supply server 100. The client 200 receives the electric power supplied from the power supply server 100, which can supply electric power matching the client's specification. At this time, the client 200 obtains a server power supply profile from the power supply server 100 and determines the specification (server power supply profile) of the power supply server 100 for use at the client 200. Specifically, the client 200 first detects a synchronous packet A1 output by the power supply server 100 and obtains the address of the power supply server 100 included in the synchronous packet A1. The address may be a MAC address, for example. Next, the client 200 transmits to the power supply server 100 an information packet D1 that requests transmission of the number (or descriptive information) of the server power supply profiles possessed by the power supply server 100. Alternatively, the request is for a description of the profiles, which simplifies the management of profile information that needs to be held in the client. The information may also include priority information used by the server to judge which client to serve in priority order.

The power supply server 100 having received the information packet D1 transmits a server power supply profile number (and/or description) in the information packet B1. The server power supply profile number is the number of the server power supply profiles of the power supply server 100. The profiles may be ordered such that if the server identifies a particular number, the client can then recall from its memory a profile that corresponds with the specific number. The client 200 having received the information packet B1 obtains from the power supply server 100 the contents of the server power supply profile with the number equal to the number of the server power supply profiles of the power supply server 100. For example when the power supply server 100 has two server power supply profiles, the client 200 first obtains one of the two server power supply profiles. The client 200 having identified which one of the two server power supply profiles it requires, it transmits to the power supply server 100 or indication of the server power supply profile (or the profile itself) in the information packet D2 requesting the use of the power supply.

In this embodiment, the power supply server 100 having received the information packet D2 transmits a first server power supply profile as the information packet B2 to the client 200. The first server power supply profile is stored in a storage part (not shown) included in the power supply server 100. The client 200 having received the information packet B2 from the power supply server 100 transmits the information packet for use in obtaining a second server power supply profile. However, the information slot IS1 terminates at this point, and the power supply slot PS1 for use in transmitting the power supply packet starts. Thus, this information packet is transmitted in the next information slot IS2. In the power supply slot PS1, since the power specification that the client 200 receives electric power from the power supply server 100 is not determined, and the electric power supply is not performed.

The power slot PS1 terminates, and the synchronous packet A2 showing the start of the next time slot is output from the power supply server 100. Thereafter, the client 200 having received the information packet B2 from the power supply server 100 transmits the information for use in obtaining the second server power supply profile as the information packet D3.

The power supply server 100 having received the information packet D3 transmits the second server power supply profile as the information packet B3 to the client 200. The second server power supply profile is stored in a storage part (not shown) included in the power supply server 100. The client 200 having received the information packet B3 to obtain the two server power supply profiles of the power supply server 100 selects the server power supply profile with a power specification matching to the client 200 itself. The client 200 then transmits to the power supply server 100 the information packet D4 for use in determining the selected server power supply profile. (Alternatively, the client 200 includes a recorded set of compatible profiles or codes, that the server 100 recognizes as describing particular profiles.)

The power supply server 100 having received the information packet D4 transmits information, which serves as the information packet B4 and represents such a response that the power specification is determined, to the client 200 so as to notify the completion of the determination of the first server power supply profile to the client 200. Thereafter, when the information slot IS2 terminates and the power slot PS2 starts, the power supply server 100 outputs the power supply packet C1 to the client 200 and supplied electric power. With regard to the timing of transmission of the power packet, a power supply start time can be designated by the client 200 to the power supply server 100 by using the information representing a transmission start time setting request.

An example of a power supply processing by the power supply system 1 according to the embodiment of the present disclosure has been explained above. Note that in the present disclosure, the power supply processing by the power supply system is not limited to this example. The power is not necessarily intermittently transmitted from the power supply server in this manner, but it may be continuously transmitted from the power supply server. Also, the server and client may use a standard set of codes that identify predetermined profiles, so that more efficient communications between the server and client will be possible when agreeing on a compatible profile. Next, a constitution of a power supply server 100 according to the embodiment of the present disclosure will be explained.

(1-3. Constitution of Power Supply Server)

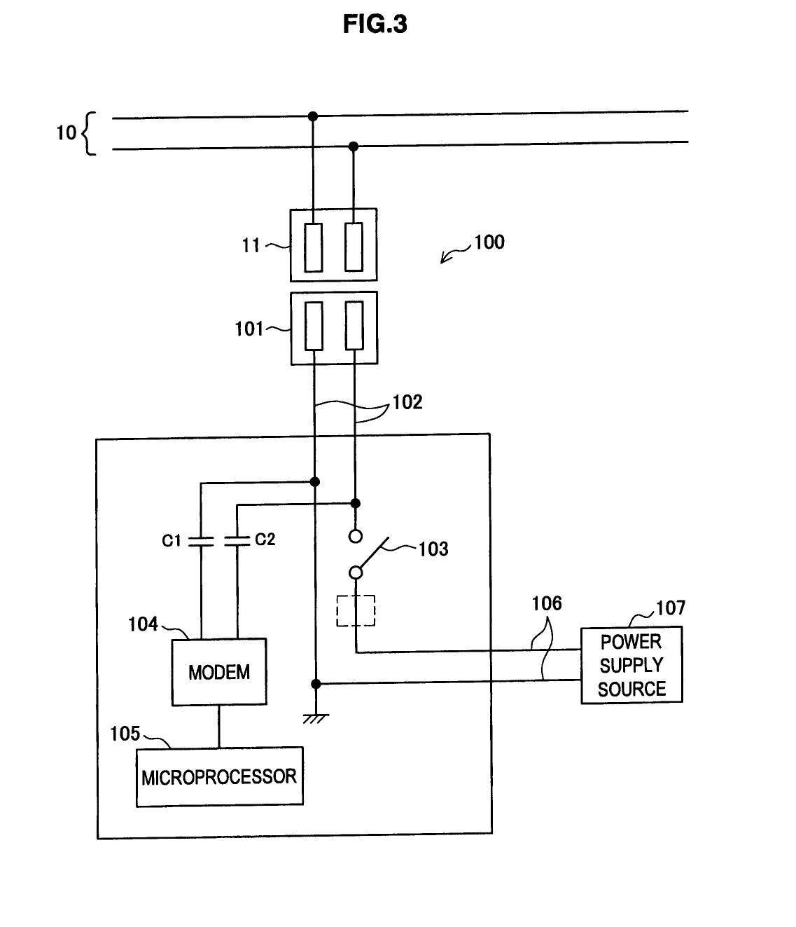

FIG. 3 is an explanatory view showing a constitution of the power supply server 100 according to an embodiment of the present disclosure. Hereinafter, the constitution of the power supply server 100 according to an embodiment of the present disclosure will be described using FIG. 3.

As shown in FIG. 3, the power supply server 100 according to this embodiment is configured to include a connector 101, connecting wires 102 and 106, a main switch 103, a modem 104, a microprocessor 105, a power supply source 107, a DC/DC converter 108, capacitors C1 and C2, and an inductor L1.

The connector 101 connects a power supply server body and the bus line 10 by connecting to the connector 11 of the bus line 10. The connecting wire 102 (multiple conductors) is used for connecting the connector 101 and the power supply server body. The main switch 103 controls an electric power output. When the main switch 103 is turned on (i.e., switch is closed), the power supply server 100 can supply electric power from the power supply source 107 to the bus line 10. Meanwhile, when the main switch 103 is turned off (switch opened), the power supply server 100 can stop the electric power supply from the power supply source 107.

The modem 104 is used for transmitting and receiving information to and from other power supply server and client connected to the bus line 10. The modem 104 transmits high frequency signals used for communication to the bus line 110, and receives the high frequency signals used for communication that is travelling through the bus line 10. Note that the capacitors C1 and C2 are arranged between the bus line 10 and the modem 104, to prevent the DC current traveling through the bus line 10 from flowing into the modem 104.

The microprocessor 105 controls the operation of the power supply server 100. When negotiation between the power supply server 100 and the client (for example, the client 200 of FIG. 1) are completed, the microprocessor 105 turns on the main switch 103 so that electric power is supplied from the power supply source 107.

The connecting wire 106 is used for connecting the power supply server body and the power supply source 107. The power supply source 107 is configured to supply electric power of DC voltage for example and can supply DC power to the bus line 10 when the main switch 103 of the power supply server 100 is turned on. As the power supply source 107, a solar panel or the like that generates electric power using sunlight irradiation for example may be used.

The DC/DC converter 108 is configured to convert a voltage of electric power supplied by the power supply source 107 into a certain proper voltage. Since the voltage is converted in the DC/DC converter 108, electric power can be supplied at a voltage matching to a request of a client receiving a power supply from the power supply server 100. Note that the DC/DC converter 108 may be a step-down DC/DC converter that inputs voltage around 7 to 30 V, for example. The DC/DC converter may also be housed within the power supply source 107.

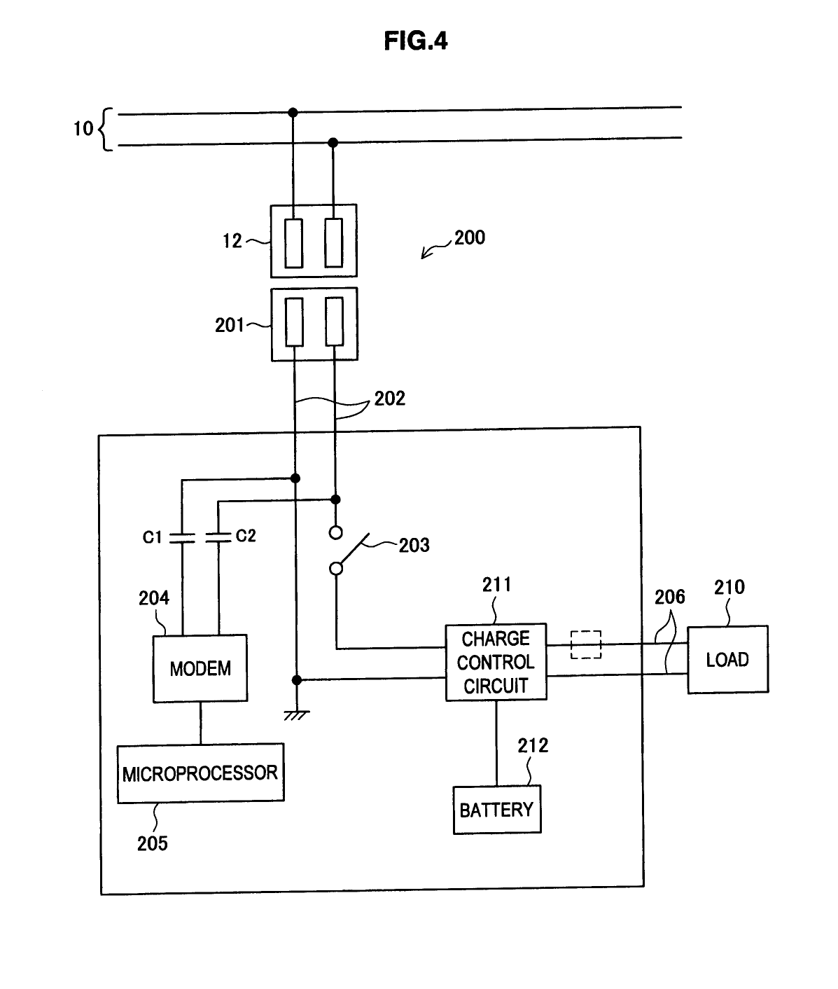

The constitution of the power supply server 100 according to an embodiment of the present disclosure has been described using FIG. 3. Next, a constitution of a client 200 according to an embodiment of the present disclosure will be explained using FIG. 4.

FIG. 4 is an explanatory view showing a constitution of the client 200 according to an embodiment of the present disclosure.

(1-4. Constitution of Client)

As shown in FIG. 4, the client 200 according to an embodiment of the present disclosure is configured to include a connector 201, connecting wires 202 and 206, a main switch 203, a modem 204, a microprocessor 205, a load 210, a charge control circuit 211, a battery 212, and capacitors C1 and C2.

The connector 201 connects the client body and the bus line 10 by connecting to the connector 12 of the bus line. The connecting wire 202 is used for connecting the connector 201 and the client body. The main switch 203 controls an electric power input. When the main switch 203 is turned on, the client 200 can receive electric power supplied from the power supply server via the bus line 10. Meanwhile, when the main switch 203 is turned off, the client 200 does not receive electric power supplied from the power supply server.

The modem 204 is used for transmitting and receiving information to and from other power supply server and client connected to the bus line 10. The modem 204 transmits high frequency signals used for communication to the bus line 10, and receives the high frequency signals used for communication that are traveling through the bus line 10. Between the bus line 10 and the modem 204, there are capacitors C1, C2 to prevent the DC current traveling through the bus line 10 from being introduced into the modem 204.

The microprocessor 205 controls operation of the client 200 and monitors voltage and electric current inside the client 200. When negotiation between the power supply server (for example, the power supply server 100 of FIG. 1) and the client 200 is completed, the microprocessor 205 turns on the main switch 203 to receive electric power from the power supply server.

The connecting wire 206 is used for connecting the client body and the load 210.

The load 210 consumes electric power supplied from the power supply server. The charge control circuit 211 is a circuit for controlling a charge and a discharge of the battery 212. The battery 212 accumulates electric power supplied from the power supply server under the control of the charge control circuit 211 and discharges the accumulated electric power to the load 210 under the control of the charge control circuit 211.

An example of the constitution of the client 200 according to an embodiment of the present disclosure has been described. Next, operation of the power supply server 100 and the client 200 according to an embodiment of the present disclosure will be explained.

(1-5. Operation of Power Supply Server and Client)

In the power supply system 1 according to an embodiment of the present disclosure, the power supply server 100 supplies electric power based on a result of negotiation with the client 200. In other words, when the power supply server 100 accepts a power supply request from the client 200, the power supply server 100 supplies electric power to the client 200. On the other hand, when the negotiation condition from the client 200 can not be satisfied and the power supply server 100 rejects the power supply request, the power supply server 100 does not supply electric power to the client 200. The negotiation between the power supply server 100 and the client 200 thus includes a power supply rejection mechanism. Thus, the power supply system 1 according to an embodiment of the present disclosure can realize effective electric power supply by introducing an idea of a client priority indicating priority of a client into negotiation between the power supply server 100 and the client 200.

The most frequently used negotiation conditions between the power supply server 100 and client 200 may be a supply voltage and a maximum current. The validity of negotiation of the first client to receive electric power supply from the power supply server may be judged based on these electric power conditions without introducing the client priority into the negotiation condition. However, when another client then starts negotiation with the same power supply server and the conditions other than the client priority are satisfied, it is preferable that the client priority is finally considered at this timing.

Here, in the power supply system 1 according to the embodiment, a client priority variable representing a client priority is defined. The value of the client priority is one byte for example and is weighted as follows for example.

255: invalid client priority
0: highest client priority value
1:
2:
:
:
254: lowest client priority value

The power supply server 100 in the coverage of the power supply system 1 according to an embodiment of the present disclosure judges the priority of electric power supply based on the value of the client priority variables. The value of the client priority variable can be dynamically modified; however, a method for setting an initial value of the client priority variable will firstly be explained.

In some cases a designer simply declares client priority variables in the above 254 levels. If the decision of the client priority variable is consciously made, the client priority variable is set to be “1” in most cases.

In this point of view, in the power supply system 1 according to the embodiment, a following classification of clients is performed, for example.

(1) no settings
(2) devices that operate in case of emergency, without emergency power
(3) devices that operate in case of emergency, with emergency power
(4) devices that operate routinely (do not have to operate in case of emergency), without backup power
(5) devices that operate routinely, with backup power
(6) operation time within a day is one hour or less, without backup power
(7) operation time within a day is one hour or less, with backup power
(8) not in use

A designer of a client sets a priority expectation value of each client based on the above classification. Then, an operation for reading the priority expectation value in the 254 levels and allocating the value to each client is executed by the power supply server 100 in the power supply system 1. In other words, the power supply server 100 allocates the priority expectation values to the clients to which the power supply server 100 supplies electric power and determines a client to which to supply electric power based on the priority expectation values. A synchronous server (the power supply server 100) of the power supply system 1 does not execute a priority process regarding an active power supply server in the coverage of the power supply system 1 and equally allocates time slots for all active power supply servers. In other words, when there is a single active power supply server (that is, the synchronous server supplies electric power and only the synchronous server is in operation), all the time slots of the power supply system 1 are allocated to the synchronous server. Priority is determined when the synchronous server sets which of those time slots are to be allocated to which client 200.

Meanwhile, when there are two or three power supply servers, time slots are equally allocated to the respective power supply servers and the priority is set among those power supply servers. Moreover, the multiple servers coordinate to share resources and augment power profiles supported.

When each power supply server sets priority to a client requesting power supply, the following algorithm (implemented on a programmable processor or through hardware) may be used, for example. In the following description, an example of an algorithm that the power supply server sets priority to clients that request power supply will be described.

The power supply server 100 firstly defines an emergency byte as a parameter. Of course other data structures of other lengths and formats may be used as well. The emergency byte is a parameter that indicates whether the condition of the power supply system 1 is a normal condition or an emergency condition, and, when it is in an emergency condition, indicates a content of the emergency condition. In the present embodiment, to simplify the explanation, an emergency byte “0” represents a normal condition and an emergency byte “1” represents an emergency condition (in other words, the emergency byte is simply used as a flag). Note that it is obvious that other values can be used as the emergency byte and the example described here does not place a limitation.

(1) When emergency byte=0

When the emergency byte is “0,” the power supply server 100 having received a power supply request from the client 200 converts a priority expectation value into a client priority variable in the microprocessor 105 as follows.

To the high 3 bits in one byte, the priority expectation value is allocated as the following order.

000: (4) devices that operate routinely, without backup power
001: (5) devices that operate routinely, with backup power
010: (2) devices that operate in case of emergency, without emergency power
011: (3) devices that operate in case of emergency, with emergency power
100: (6) operation time within a day is one hour or less, without backup power
101: (7) operation time within a day is one hour or less, with backup power
111: (1) no settings

Meanwhile, to the low 5 bits, random numbers are allocated to registered clients in order. Since random numbers are allocated in this manner, a random priority order is allocated to each client. In a case where there is a single client, even when any random number is allocated, the random number value is the smallest value and electric power is supplied to this client on the top-priority basis. Then, to a second or subsequent client, a random value other than the allocated value is allocated.

These values are randomly determined so that fairness is maintained; however, when a value is once fixed, the priority order is also fixed, so these values may be reallocated in every predetermined time period (one day for example).

(2) When Emergency Byte=1

When the emergency byte is “1,” the power supply server 100 having received a power supply request from the client 200 converts a priority expectation value into a client priority variable in the microprocessor 105. When the emergency byte is “1,” the priority order of the high 3 bits in one byte is modified from that of the case where the emergency byte is “0” as follows.

000: (2) devices that operate in case of emergency, without emergency power
001: (3) devices that operate in case of emergency, with emergency power
010: (4) devices that operate routinely, without backup power
011: (5) devices that operate routinely, with backup power
100: (6) operation time within a day is one hour or less, without backup power
101: (7) operation time within a day is one hour or less, with backup power
111: (1) no settings

Note that the low 5 bits are the same as that in the case where the emergency byte is “0.”

In this method, the maximum number of clients manageable in each power supply server is limited to 254; however, this maximum number will not cause a problem since the power supply system 1 according to the present embodiment is originally configured to perform intermittent power supply from the power supply server 100 to the client 200. If necessary; however, the data structure may be modified to manage more clients by increasing the number of the bytes.

Although the power supply server 100 chooses a client to supply electric power based on the client priority variable as described above, when power supply ability of the power supply server becomes poor, power from the power supply server 100 will not be supplied to clients, in order, whose negotiation conditions are not satisfied regardless of the value of the client priority variables. The client priority variable is used to set priority when the electric power amount among the power supply conditions is satisfied. Thus, when a client has a wide acceptable range (of voltage or current, for example), the priority of the client becomes automatically high because the power supply condition is satisfied.

Next, a priority control in a case where the power supply server 100 supplies electric power to plural clients 200 at the same time will be explained. When the power supply server 100 supplies electric power to plural clients 200 at the same time, since the present supply amount in the power supplier side is the sum of the supply amounts of the power supply servers 100, the supply amount in the power supplier side dynamically changes due to the present power generation amount and the capability (especially an electric power storage provided to the power supply server 100) of the power supply server 100. This is the difference from the case of intermittent power supply.

Meanwhile, the client 200 connected to the power supply system 1 is provided with an electric power storage device such as the battery 212 so that the client 200 also has potential electric power supply ability. However, regarding the electric power storage of the client 200, as long as the client 200 is not registered also as a power supply server in the power supply system 1, the client 200 is not recognized as having potential supply ability in the system. (In other words, if the client 200 has a will to have its battery 212 open to the system, the client 200 will be registered as a client in the power supply system 1 and also registered as a power supply server in the power supply system 1 at the same time). Even when the client 200 is registered as a power supply server in the power supply system 1, the client 200 does not have to respond to a power request from another client if its profile is set so that the power supply ability is zero. Thus, the recognition of the total amount of power supply can be the sum of the total amounts of power supply of the power supply servers.

Further, when the first client 200 is connected to the power supply system 1 and the client 200 requests electric power to the power supply server 100, the priority of the client 200 is not a negotiation condition. It is firstly and simply judged whether electric power can be supplied to the client 200 based on whether the power supply amount of the power supply server 100 and its power specification match the request of the client 200. Meanwhile, in a case where a power supply is already being performed between the (one or more) power supply server 100 and the (one or more) client 200, the above described client priority variable becomes significant when another client 200 tries to join the power supply system 1 and further the power supply amount from the power supply server 100 does not satisfy the demand of all the clients 200.

In the power supply system 1 according to the present embodiment, the client 200 that is going to receive power supply negotiates an electric current amount with the power supply server 100 after checking that the present supply voltage is being satisfied. Although the present supply voltage is checked by inquiring to the power supply server 100, it can be prospected at a certain degree when the client 200 physically measures the voltage of the bus line 10. Here, in the latter case, it is preferable that the client 200 is provided with a measurement path for physically measuring the voltage of the bus line 10 in addition to the main switch 203. Here, the process of the negotiation between the power supply server 100 and the client 200 may include a modification of the present supply voltage. When the client 200 is applicable to this voltage modification and the electric current requested by a client 200 newly connected to the power supply system 1 is greater than the allowance current that is actually available to supply from the power supply server 100, the above client priority variable becomes increasingly significant.

In the case where the power supply server 100 supplies electric power to plural clients 200 at the same time, it is assumed that the initial settings of the client priority variables are the same as the above. In other words, each client sets an approximate value in advance and, when the client 200 is connected to the power supply system 1, a client priority variable is determined at the timing that the client 200 is registered to the power supply system 1 (registered to the synchronous server). Here, differently from the above, the low 5 bits of the client priority variable of the client are set unique in the system, not unique in the power supply server.

Concretely, the client priority variable is determined by the synchronous server (for example, the power supply server 100) and managed by the synchronous server. Since the above method is used, the synchronous server determines client priority variables every time when a client 200 is added to the power supply system 1 and manages the client priority variables in a list. Further, regarding the value of the client priority variable (especially the low 5 bits), the synchronous server can newly re-determine the value in every predetermined time periods, not only at the initial determination, so that the fairness among clients can be improved.

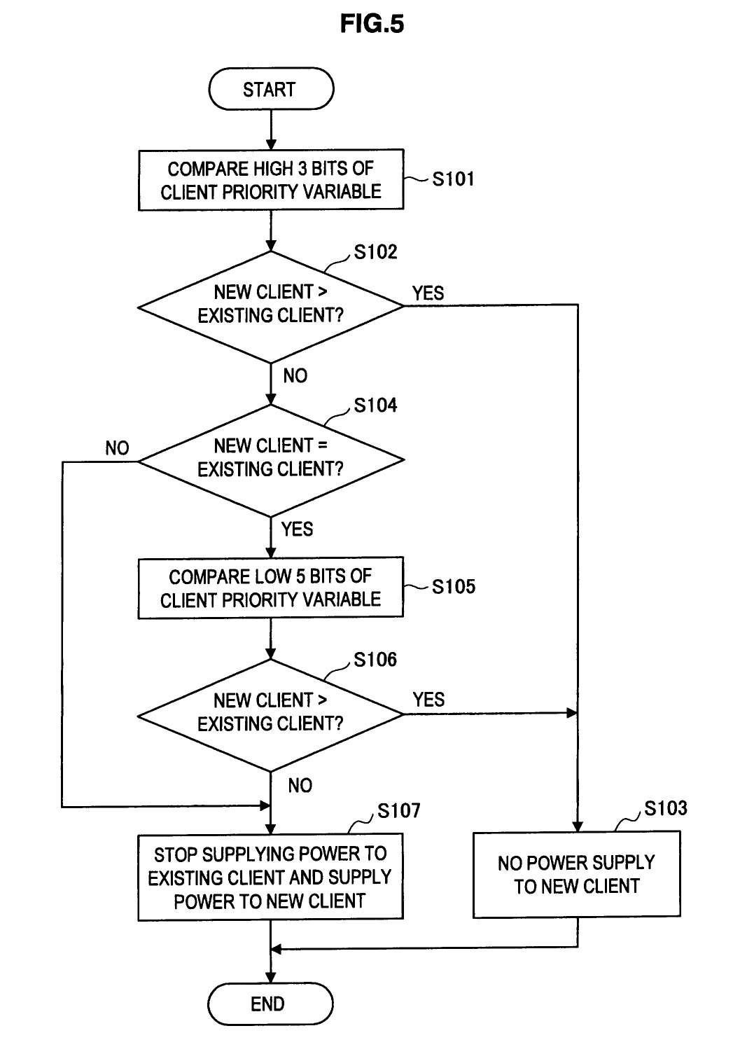

An example will be described how the power supply server deals with a client 200 newly connected to the power supply system 1 with the above described conditions. FIG. 5 is a flowchart showing an example of a priority control in a case where the power supply server 100 supplies electric power to plural clients 200 at the same time. Hereinafter, a priority control in a case where the power supply server 100 supplies electric power to plural clients 200 at the same time using FIG. 5. Note that the following series of processes are executed under a control of the microprocessor 105.

When a client 200 is newly connected to the power supply system 1, a power supply server 100 which is selected as a synchronous server compares the high 3 bits of the client priority variable of the newly connected client 200 with the high 3 bits of the client priority variable of a previously connected client 200 (step S101), and determines whether the client priority variable (the high 3 bits) of the newly connected client 200 is greater than the client priority variable (the high 3 bits) of the existing client 200 (step S102). The comparison and magnitude determination of the client priority variables are executed by the microprocessor 105 for example.

As a result of the judgment in step S102, when the client priority variable of the newly connected client 200 is greater than the client priority variable of the existing client 200, the power supply server 100 determines not to supply electric power to the newly connected client 200 (step S103). Meanwhile, as a result of the judgment in step S102, when the client priority variable of the newly connected client 200 is not greater than the client priority variable of the existing client 200, the power supply server 100 further judges whether (the high 3 bits of) the client priority variable of the newly connected client 200 is equal to (the high 3 bits of) the client priority variable of the existing client 200 (step S104).

As a result of the judgment in step S104, when the high 3 bit of the client priority variable of the newly connected existing client 200 is equal to the high 3 bits of the client priority variable of the existing client 200, the power supply server 100 further compares the low 5 bits of the client priority variable of the newly connected existing client 200 with the low 5 bits of the client priority variable of the existing client 200 (step S105) and judges whether the low 5 bits of the client priority variable of the newly connected existing client 200 is greater than the low 5 bits of the client priority variable of the existing client 200 (step S106).

As a result of the judgment in step S106, the low 5 bits of the client priority variable of the newly connected client 200 is greater than the low 5 bits of the client priority variable of the existing client 200, the power supply server 100 determines not to supply electric power to the newly connected client 200 (step S103). Meanwhile, as a result of the judgment in step S106, when the client priority variable of the newly connected existing client 200 is not greater than the client priority variable of the existing client 200, and further, as a result of the judgment in step S104, when the high 3 bits of the client priority variable of the newly connected client 200 is not equal to the high 3 bits of the client priority variable of the existing client 200, the power supply server 100 stops supplying electric power to the existing client 200 and starts to supply electric power to the newly connected client 200 (step S107).

Here, when the priority of the newly connected client 200 is higher than the priority of the existing client 200, the power supply server 100 inquires the existing client 200 (whose priority is lower than the priority of the newly connected client 200) whether electric power of reduced electric current is acceptable before simply stopping the power supply to the existing client 200. If acceptable, the existing client 200 responds to the power supply server 100 that electric power of reduced electric current is acceptable, and the power supply server 100 supplies power to the existing client 200 after reducing electric current and allocates electric current to the newly connected client 200. Here, when there are plural existing clients 200, the power supply server 100 may reduce electric power supplied to an appropriate number of clients 200, not only the electric power allocated to one client 200.

Thus, it is easier to receive electric power supply from the power supply server 100 if the client 200 has plural profiles specifying electric current amounts or a profile setting having a wide range of acceptable electric current amounts. Note that when the priority of the client 200 is set high, it is possible to receive electric power supply from the power supply server 100, however, the priority setting is assumed to be properly applied based on the above rule.

Regarding the clients 200 having the same upper priority (the high 3 bits of the 1-byte client priority variables), the synchronous server resets the lower priority (the low 5 bits of the 1-byte client priority variables) according to need, and this prevents that the client priority variables are kept fixed. However, it is assumed that a client 200 whose upper priority is low may not receive electric power supplied from the system forever and the fairness among the clients 200 is not maintained.

From this point of view, in order to maintain the fairness among the clients 200, for example, the power supply system 1 may monitor the conditions of the synchronous server supplying electric power to the clients 200 and, to perform a priority control, may give a chance to a client 200 that has been rejected for a while to receive electric power supply from the power supply server 100 by resetting its upper priority. Such a process should be a temporal process and, when electric power is once supplied to this client 200, the synchronous server may set its upper priority back to the original value.

When a client 200 is newly connected to the power supply system 1, the power supply request from the client 200 to the power supply server 100 may be rejected since its priority is low. Especially, in a case of a device in which a client 200 is dynamically connected and disconnected to the power supply system 1 by a user, it is assumed that the user connects the client 200 since electric power is needed. In such a case, judging electric power supply simply based on only the priority level is not a preferable operation.

For this reason, such a device may be provided with a display unit such as an LED and a priority modify switch (a button). In other words, if it is found that electric power will not be supplied even when the client 200 is connected to the power supply system 1, the client 200 can alert a user by lighting the LED for example to allow a manual priority setting by the user.

The manual priority setting by a user may lead the user to input a specific value or may lead the user to press a button once so that the setting of priority is temporarily set at the highest level. When the priority is temporarily set at the highest level, the setting of the priority may be set back to the default value of the device after electric power supply to the device is performed.

A realistic power supply by the power supply system 1 that has a limited capacity is realized by providing a display showing a priority condition of the device and means for encouraging a user to modify the priority and by preparing priority modification means used by the user. One technique for increasing to a top priority for example is a repeated connection/disconnect/connect sequence, which signifies that the user would like a quick charge for a particular client. One example situation is that the user needs to complete a task with his cell phone in the near term, and thus needs at least a small amount of charge very quickly. Also, a client may be configured to select when it has a sufficient charge (but not full charge) to operate the device for a predetermined time such as one hour. The client can inform the server that it releases its priority status and allows for other devices to have access to power from the server(s).

Regarding the priority of each client, an overwrite function used by a user may be practical in addition to the default value set when shipped from a factory. As the method for overwriting, a method of rewriting priority data of a client though a PC or the like, a rewrite using a button, or a temporal modification using a button may be applied for example. When the priority data of a client is rewritten through a PC, in addition to preparing an interface such as a USB to the client itself for example, a monitor system having a function relevant to the PC and connected to the power supply system 1 may be used.

The power supply control for an existing client and a newly connected client 200 in a condition where electric power is being supplied from the power supply server 100 to the existing client 200 is executed as described above, and there may be a client in a standby state without receiving power supply due to its voltage specification or the like. Among the clients in a standby state, there may be a client having a high priority of power supply. In the following description, a method for controlling such a client will be described.

The most simple control is to preemptively set a maximum supply time to a client to which the power supply system 1 firstly starts to supply electric power and the electric power is continuously supplied during the period, and then, to start negotiation of power supply from the power supply server with a client being in a standby state. The power supply negotiation is started upon the synchronous server outputs a packet indicating that the preemptive supply to a client to which power supply is firstly started is completed to the client existing in the power supply system, but such a packet may be output when the preemptive supply is close to complete, in order to save the time. This is because the synchronous server knows the completion time of the preemptive supply.

At this timing, negotiation with the client that has been in standby state is prioritized over the client to which power has been supplied. Note that the “prioritize” is not related to the client priority variable of the client. Then, the client in the standby state starts to negotiate with the power supply server and, if the negotiation is successful, power supply from the power supply server can be received.

As a result, power supply to the client in a standby state can be realized by giving the client (in a standby state) a prioritized negotiation right in a unit of preemptive power supply time provided by the synchronous server, without considering the priority variable of the client.

In the above description, the client priority variables provided to the clients in a standby state do not affect the priority of the clients, but are used in a priority control among the plural clients. Here, a case will be described in which negotiation is prioritized when there is a client having a client priority variable of a high priority among the clients being in a standby state.

In the power supply system 1 according to the embodiment, a client starts negotiation to find whether power supply is available. This is because it is more natural that a receiver of electric power shows a will to receive power. In other words, as a trigger of its power request, the client starts to negotiate with the power supply server; however, according to the above description, when the negotiation with the power supply server does not go well (in other words, it is when the power supply server has supply ability to satisfy the specification of the client, but the present set value does not match the request of the client), the client waits to negotiate until a power supply server is newly added or a packet indicating that preemptive supply is going to be completed is sent to the bus line 10.

On the other hand, after the client 200 acquires a server profile from the synchronous server, the client 200 compares the profile with its own profile and, when it is determined that power reception is available, checks the high 3 bits of the client priority variable. Then, a client whose high 3 bits are within a predetermined range, for example from a range of 000 to 001, requests the power supply server to review preemptive time according to need. When it is found that the profile of the present power supply server does not satisfy the request specification of the client, the client does not make a further action (The next time a chance for power supply is given is when a power supply server added to the power supply system is detected.).

The power supply server 100 having received a request of reviewing the preemptive time compares the client priority variables of one or more clients 200 to which power is currently supplied with the client priority variable of the client 200 as a requesting source. The client priority variable of the newly connected client 200 (the client 200 as a requesting source) is compared with all the client priority variables of the one or more clients 200 to which power is being supplied, and when the priority of the newly connected client 200 is higher than those of all existing clients, the power supply server 100 stops supplying power to the existing clients and starts to negotiate with the newly connected client 200. With this configuration, it is assumed that the newly connected client 200 will succeed the negotiation with the power supply server 100.

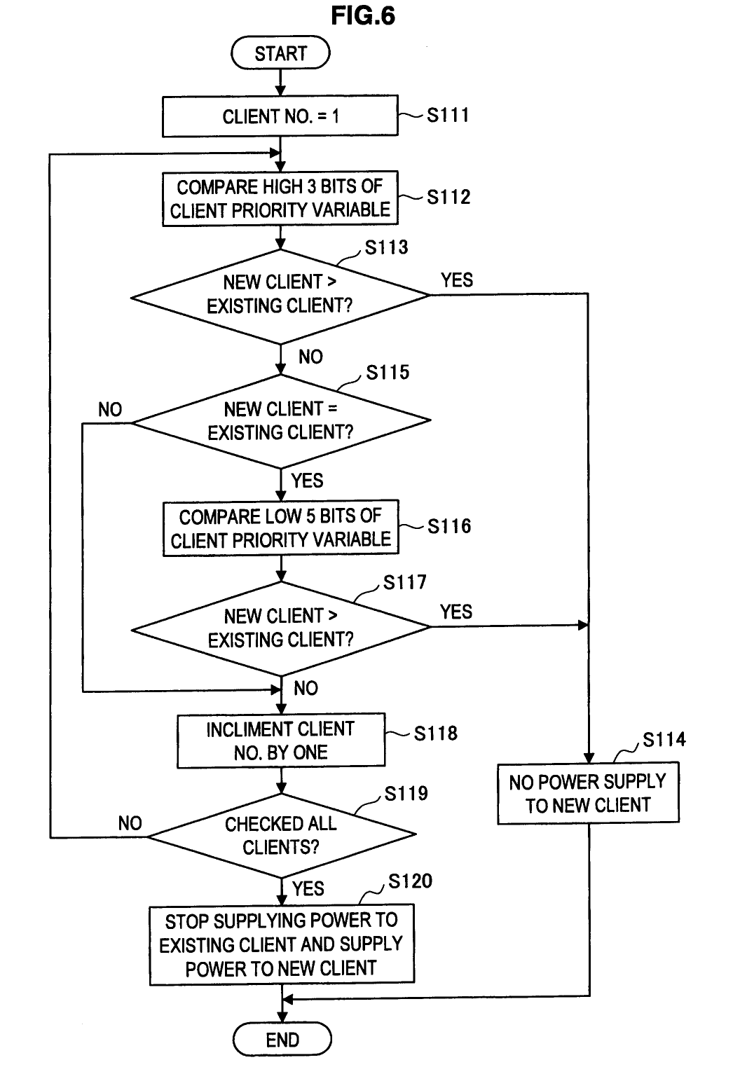

FIG. 6 is a flowchart showing another example of a priority control in a case where the power supply server 100 supplies electric power to plural clients 200 at the same time and shows a case where a priority control is executed by comparing a client priority variable of a newly connected client 200 (a client 200 as a requesting source) with all client priority variables of one or more clients 200 to which power is being supplied. In this case, it is preferable that the power supply from the power supply server 100 is continuously performed, not intermittently as shown in FIG. 2. Hereinafter, the another example of a priority control in a case where the power supply server 100 supplies electric power to plural clients 200 at the same time will be explained using FIG. 6. Note that the following series of processes are executed under a control of the microprocessor 105.

To compare the client priority variable of the newly connected client 200 with client priority variables of all clients 200 to which power is being presently supplied, the power supply server 100 firstly sets “1” as a client number N of the first client 200 among the clients 200 to which power is being presently supplied (step S111). Next, the power supply server 100 compares the high 3 bits of the client priority variable of the newly connected client 200 with the high 3 bits of the client priority variable of the first client 200 (step S112) and judges whether (the high 3 bits of) the client priority variable of the newly connected client 200 is greater than (the high 3 bits of) the client priority variable of the existing client 200 (step S113). The comparison and largeness determination of the client priority variables are executed by the microprocessor 105 for example.

As a result of the judgment in step S113, when the client priority variable of the newly connected client 200 is greater than the client priority variable of the existing client 200, the power supply server 100 determines not to supply electric power to the newly connected client 200 (step S114). Meanwhile, as a result of the judgment in step S113, when the client priority variable of the newly connected client 200 is not greater than the client priority variable of the existing client 200, the power supply server 100 further judges whether (the high 3 bits of) the client priority variable of the newly connected client 200 is equal to (the high 3 bits of) the client priority variable of the existing client 200 (step S115).

As a result of the judgment in step S115, when the high 3 bits of the client priority variable of the newly connected client 200 is equal to the high 3 bits of the client priority variable of the existing client 200, the power supply server 100 further compares the low 5 bits of the client priority variable of the newly connected client 200 with the low 5 bits of the client priority variable of the existing client 200 (step S116) and judges whether the low 5 bits of the client priority variable of the newly connected client 200 is greater than the low 5 bits of the client priority variable of the existing client 200 (step S117).

As a result of the judgment in step S117, when the low 5 bits of the client priority variable of the newly connected client 200 is greater than the low 5 bits of the client priority variable of the existing client 200, the power supply server 100 determines not to supply electric power to the newly connected client 200 (step S114). Meanwhile, as a result of the judgment in step S117, when the client priority variable of the newly connected client 200 is not greater than the client priority variable of the existing client 200 and, as a result of the judgment in step S115, when the high 3 bits of the client priority variable of the newly connected client 200 is not equal to the high 3 bits of the client priority variable of the existing client 200, the power supply server 100 increments the value of the client number N by “1” (step S118) and judges whether the checking of all existing clients 200 is completed (step S119). When the checking is not completed, the process goes back to step S112 and, when completed, the power supply server 100 stops supplying power to the existing clients 200 and starts to negotiate with and supplies power to the newly connected client 200 (step S120).

The another example of a priority control in a case where the power supply server 100 supplies electric power to plural clients 200 at the same time has been described by using FIG. 6.

### 2. CONCLUSION

As described above, according to an embodiment of the present disclosure, an effective priority control in a case where a client 200 is newly connected to a power supply system 1 is realized by introducing an idea of a client priority variable. This priority control is effective not only in intermittent power supply by the power supply server 100 but also in continuous power supply and this enables power supply according to the priority of clients 200.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2009-295580 filed in the Japan Patent Office on Dec. 25, 2009, the entire content of which is hereby incorporated by reference.

What is claimed is:

1. A power server comprising:
an interface configured to receive a power request from a client device, said power request including client specific information; and
a processor configured to determine a priority for delivering power to said client device according to said client specific information.

2. The power server of claim 1, wherein:
said client specific information includes a client priority variable; and
said processor determines said priority according to said client priority variable received from said client device.

3. The power server of claim 2, wherein:
said processor determines said priority based on a comparison of said client priority variable with another client priority variable received by said interface for another client device.

4. The power server of claim 1, wherein:
said client specific information includes a client ID; and
said processor determines said priority based on the client ID received from said client device.

5. The power server of claim 4, wherein:
said processor determines said priority based on a comparison of respective client classifications for the client device and another device.

6. The power server of claim 1, wherein:
said client device is an electric vehicle, and said interface provides power to said electric vehicle according to the priority set according to the client specific information in said power request from the electric vehicle.

7. The power server of claim 1, wherein:
said processor is configured to initiate a priority check when another device is newly coupled to said interface, and send power to said another device if the another device has client specific information that is recognized as being of a higher priority than the client specific information for the client device.

8. The power server of claim 1, wherein said interface is configured to:
connect to a bus on which said client device is connected and other client devices are connectable and transmit respective power requests; and
deliver a power packet to said client device on said bus, according to a power profile for said client device, wherein
said power request is received during a first time slot, and said power packet is transmitted by the power server over said bus during a second time slot.

9. A client device comprising:
a processor configured to generate a power request to be transmitted to a power server, said power request including client specific information; and
an interface through which said power request is transmitted to said power server, and power is received in response from said power server according to a priority associated with said client specific information.

10. The client device of claim 9, wherein:
said client specific information includes a client priority variable, wherein
said power server determines said priority from said client priority variable by comparison with another client priority variable from another client device.

11. The client device of claim 9, wherein:
said client specific information includes a client ID, wherein
said power server determines said priority based on a comparison of respective client classifications for the client device and another device.

12. The client device of claim 9, wherein:
said client device is an electric vehicle and said interface receives power from said power server according to the priority set according to the client specific information in said power request from the electric vehicle.

13. The client device of claim 9, wherein:
said processor is configured to generate the power request when the interface is connected to the power server via a bus.

14. The client device of claim 9, wherein said interface:
connects to a bus on which said power server and other client devices are connectable; and
receives a power packet from said power server via said bus, according to a power profile for said client device, wherein
said power request is transmitted on the bus during a first time slot, and said power packet is received over said bus during a second time slot.

15. A method for serving electrical power to a plurality of devices comprising:
sending a power request from a client device to a power server, said power request including client specific information; and
establishing with a processor a priority for delivering power to said client device based on said client specific information.

16. The method of claim 15, wherein:
said establishing establishes said priority by comparing a client priority variable to another client priority variable from another client device, said client priority variable being included in said power request.

17. The method of claim 15, wherein:
said establishing establishes said priority by comparing respective client classifications for the client device and another device using a client ID for the client device, said client ID being included in said power request.

18. The method of claim 15, further comprising:
initiating said establishing when the client device is newly connected to a bus that interconnects said power server and said client device.

19. The method of claim 15, further comprising:
conveying a power packet from said power server to said client device according to a power profile for said client device.

20. The method of claim 15, further comprising:
sending power packets to said client device but not to another device when said client device has a higher priority status than said other device;
checking for a change in status and whether said another device has a higher priority status than said client device; and
sending power packets to said other client device when said checking identifies said other client device as having a higher priority status than said client device.
